(19) United States
(12) Patent Application Publication
(10) Pub. No.: US 2002/0092380 A1
(43) Pub. Date: Jul. 18, 2002

(54) Gripwheel driver and method of attachment to obtain unique properties

(76) Inventor: David Arthur Woodsum, New Orleans, LA (US)

Correspondence Address: MR. DAVID A. WOODSUM, 2623 GLADIOLUS STREET, NEW ORLEANS, LA, 70122, US

(21) Appl. No.: 10/022,625

(22) Filed: Dec. 13, 2001

Related U.S. Application Data
(63) Continuation-in-part of application No. 09/309,640, filed on May 11, 1999, now abandoned.

(51) Int. Cl. B25B 13/00

(52) U.S. Cl. 81/58.1

(57) ABSTRACT

A second handle assembly used on a driver-tool, the tool having a handle and shank extending perpendicularly from the handle, the assembly attached by prescribed method, location fixed upon, relative the shank, and having separate shaped halves, one discrete half being held by, guided to against work by, serving to position rotatable about the shank, a one hand-portion of a user/operator's hand which positioned, positions a second portion of the hand free to orbit, grasp, hold, and release the assembly's other half, the hand's second portion as positioned used for improving ratcheting, spinning the other half-assembly spinning the shank, and acting as clutch releasing the shank to move easily within the grasp thus enhancing an alternating two handed continuous spinning of the shank. The assembly having halves shaped and located, offers as platform to support installation of means equalizing ability of one hand, gripping from positioned along side the tool, to spin the tool's shank, with ability of an other hand spinning the shank from positioned gripping on tool's rear. The assembly comprises a slip-ring-type-hand-held-guide, first half assembly, attached girdling the tool's shank loosely thereby freely, separately, able to spin, unlimited in direction relative the shank as axis; and a hand-operated-drive-wheel, other half assembly, attached separately adjacent in line rearward of the guide, forward of the driver-handle, and girdling while engaging the shank, thereby the shank spins with the wheel's spin but the guide spins separate.

### CROSS REFERENCE TO RELATED APPLICATION

This application is a continuation in part of application Ser. No. 09/309,640 filed May 11, 1999 entitled Gripwheel Driver Assembly and Method Of Use.

### BACKGROUND OF THE INVENTION

1. Field of the Invention

The present invention relates to devices by which Driver Tools are actuated and handled.

2. Description of Prior Art

Ratchet Drivers are designed to eliminate both the need for disengaging from a fastener to return for another leg of spinning a driver tool's handle and the need for reconfiguring the grip to begin application of another spin of the driver's handle, operations necessary for rotation of a fastener in absence of a ratcheting mechanism. By eliminating the aforementioned operations, the time saved can be applied to just rocking the driver's handle back and forth with the hand, thereby increasing the number of rotational cycles and speeding rotation of the fastener. However, due to the fact that many fasteners are not snug enough to generate the frictional resistance required to cause the ratchet mechanism to ratchet, the opposing hand must, at times, be used to supply the additional frictional resistance. When a means is not provided to keep the hand poised in readiness while waiting to apply the resistance, applied only during return strokes, the hand must continually reconfigure on each successive cycle to correctly apply the added resistance, thus consuming much of the time saved by using the ratchet driver. If it becomes necessary for the fastener's spin to be reversed for any reason, the user must stop, reset the ratchet mechanism for reverse, spin the fastener, then stop, reset the ratchet mechanism for forward, and resume operation; the resetting of the mechanism wastes an additional period of time. Furthermore, since the hand which is already positioned on the side of the driver's shank to apply the additional resistance, could, but being it lacks an efficient means to engage the shank and therefore cannot effectively continue spinning of the fastener, the return cycle is left unproductive and its potential not fully realized. In addition, when a hand grips the shank from a location on side the shank to spin the shank, it is not quite in spacial orientation such that it can rotate a distance equal to the distance rotated by a hand gripping on a driver handle at rear of the driver, a rotating ratio of two to three. Therefore a driver would benefit from an attached component devised so that the user's hand could act a role of clutch mechanism which normally is needed as part of the tool in order to have the tool's shaft move easily within the hand to achieve an alternating two handed continuous spin of the shank. Having such an attachment would free tool space permitting installation of, plus offer as platform to support, a means for stepping up the movement of the shank relative the movement of a hand which, while positioned along side the shank, spins the shank. Finally, since rocking the driver's rear-handle back and forth makes it difficult to hold the tool steady upon a fastener, the tool would benefit from an efficient means to guide the fore-portion of the tool against the work while operating the tool.

### SUMMARY OF THE INVENTION

It is therefore an object of the invention to equip a driver tool, a tool having both a handle and shank extending perpendicularly from the handle, with a handle assembly used as both a second-handle, for spinning the driver's shank, and a guide means, used to aid in guidance of both the driver-tool and operating hand. The assembly is comprised of two separate shaped, positioned, utilized, and functioning halves, a discrete slip ring type hand-held-guide and a hand-operated driver-shank's drive-means called a drive-wheel herein. Both halves being attached upon the tool utilizing a method of attachment prescribed herein to enable a one portion of a hand grasping upon the guide half of the assembly to direct the tool's shank toward work and, through way of the gripping upon the guide, secure the one hand portion both linearly fixed relative plus rotatable relative the shank as axis, and thereby position an unencumbered second portion of the hand to simultaneously, at will, grasp for holding or grasp for spinning the hand-operated drive-wheel-half of the assembly; and in addition through the grasp of the drive-wheel also enable the drive-wheel to (1) be means for the hand's second portion to aid in guidance of the tool; (2) be means for the hand's second portion to supply additional frictional resistance for augmenting ratcheting of the driver when the driver is a ratchet type applied to loose-fitted-work; (3) be means for the hand's second portion to reverse the spin of the driver's shank without having to reset the ratcheting direction of the driver and; (4) be means for the hand's second portion to continue productive spinning of a fastener during the opposing hand's unproductive driver-handle return strokes. To accomplish the aforementioned results the said guide and drive-wheel are structured as two separate shaped, positioned, utilized and functioning halves, both components structured and sized such that the distance from at lease one axially-parallel-outward-surface of the guide to axis of the guide is essentially the same as the distance from the overall axially parallel outward surface of the drive-wheel to axis of the drive-wheel, the driver-tool's shank being used as the axis, and both components are sized so that their widths, as placed adjacent in line on the shank as axis, are such that a hand is able to grasp the two components simultaneously, and hand-held-guide's shank-parallel outward-surface is shaped to enable holding in position on the guide any one portion of a hand grasping on the-shank-parallel-outward-surface of the said guide, while the drive-wheel's shank-parallel-outward-surface is shaped for ease of being, simultaneously along with holding, of the guide by a one portion of a hand, intermittently gripped, held, spun, and released by the grasp of any second, remaining not utilized on the guide, portion of the same hand; and additionally, the drive-wheel being a separate utilized and functioning half of the assembly, is shaped with bluntly curved surfaces substantially uniformly symmetrical about the axis of the wheel, to enable the wheel to rotate within the grasp of a releasing, not-utilized-on-the-guide, second portion of the said hand, such that the, not-utilized-on-the-guide, second portion of the said hand is able to remain in a positioning for gripping the drive-wheel, and yet also is able to rotate about the drive-wheel near or lightly touching the drive-wheel's surface due to anchoring through linkage with the said hand's one portion which remains utilizing the guide, the guide in addition being discretely freely rotatable. The assembly's method of attachment comprises, having the slip ring type hand-held-guide slipped into place “loosely discretely girdling the shank of the driver-tool and separate the drive-wheel to result in the guide's being freely, discretely separately able to spin, unlimited in distance and direction, including relative both the driver's shank as axis for the spin and the assembly's drive-wheel as a separate utilized and functioning half of the assembly, the attachment being by having the shank inserted through a bore”, larger in diameter than the shank and piercing through the guide, to a distance on the shank from the shank's work end, such that the guide is girdling rearward of in line with the shank's work end, the guide being retained in the guide's location on the shank; and the location on the shank the guide girdles is also in line forward the work side of the drive-wheel, the drive-wheel being located ringing to encircle the shank but “utilizing a manner of engaging upon the shank” to spin the shank, the location the wheel is ringing on the shank being even further in line rearward on the shank than the guide's location from the work end of the shank, the wheel being retained in the wheel's location on the shank; and the location on the shank which the wheel rings is also in line forward the work end of the driver's handle, the work end of the driver's handle being the fore-portion of the handle being a part of the driver-tool which is attached engaging upon and in line with the rear end of the tool's shank, the opposite shank-end from the tool's work end, to spin the shank, thus the driver's handle is in line rearward the drive-wheel, the drive-wheel is in turn, in line rearward the guide, and the guide is in turn, in line rearward the work end of the shank; and both the gripwheel halves, the guide and wheel, are attached advantageously positioned near enough each other between the fore-portion of the driver's handle and the tool's work end, such that a single hand is able to simultaneously grasp both the guide and drive-wheel utilizing them as bilaterally supporting halves. At least one retainer is places, a retainer in front of the hand-held-guide, to help retain the components in assembled operating position. The manner of the wheel's engagement with the shank to spin the shank can be in either on of two ways, one by having the wheel ring the shank so as to encircle fixed to the shank or two by having the wheel ring the shank rotatable relative the shank by inserting the shank loosely fitting through a bore piercing through the drive-wheel while the wheel is also dressed to engage the shank by way of linkage through a drive-train to spin the shank. The means utilized to effect the drive-wheel's engagement with the shank can be of any type including 1, having the shank's outside surface expanded and reshaped to form the drive-wheel component, by 2, dressing the inner surface of a bore through the drive-wheel with means which causes the wheel to grip the shank's surface so that the drive-wheel can have the shank inserted through the bore with the means causing the shank to be fixed to the wheel, or by 3, having a geared-internal-drive-train attached to the wheel and linking the wheel so to engage the shank, the train comprised of a loosely girding the shank beveled-driving-gear centered and fixed to the drive-wheel's internal face, the driving-gear's teeth engaging a beveled-idler-gear able to spin being mounted at its center on an axle affixed to the driver handle's fore-portion, the same beveled-idler-gear having its teeth engaging a step-up-beveled-gear able to spin being mounted at its center on an axle affixed to the driver handle's fore-portion, the step-up-beveled-gear engaging a ringing the shank while engaging the shank driven-gear; and the aforementioned gearing arrangement can be repeated in bilaterally symmetrical fashion on the shank's opposite side. Such a drive-train would be for increasing the speed of the shank's spin relative the speed of the drive-wheel's spin, thus compensating for any difference in the ability of one hand to spin the drive-wheel versus the other hand to spin the driver's rear-handle, a difference due to spacial orientation. The manner of guide's being freely, discretely separately able to spin, unlimited in distance and direction, including relative both the driver's shank and the assembly's drive-wheel, can be either one of two ways, having a bore through the guide sized so that the shank can be directly inserted loosely fitted through the bore immediately relative the guide, the shank thereby acting as axle for the guide which, being discretely separate component, is thus freely, discretely separately, able to spin unlimited in distance and direction relative the driver's shank and the assembly's drive-wheel; or the guide can also be freely, discretely separately able to spin relative the shank and drive-wheel, by having another component inserted loosely fitted through the guide's bore, the other component in turn ringing the shank to encircle the shank. As for example, the bore could be sized so that an extension of the drive-wheel's hub can be inserted loosely fitted into the guide's bore, the drive-wheel's hub would then act as axle for the guide, the guide being a discretely separate component is thus freely, discretely separately able to spin relative the hub; however, the shank inserted through the hub also enables the guide to be freely, discretely separately able to spin as relative the driver's shank, plus the wheel's hub, along with the drive-wheel, the wheel being a separate utilized half of the assembly unitized with the hub. Although the manner of attaching guide to a tool can be either one of the two ways, the means to effect the attachment as such can be only one, that is by having the guide rotationally unengaged, either directly and or by linkage, with shank.

As heretofore described the invention provides the driver tool with a second handle that is both a guide and second drive-means combined in an assembly form for handling the said tool more efficiently, augmenting operation of the said tool, and increasing the distance the tool's shaft can be turned during application cycles. The assembly's capability of providing as such being due to having the two separate yet bilaterally supporting halves, the forward half of half of the handle assembly, being the slip ring type hand-held-guide which is attached to spin discretely freely about the tool's shank, and the rear half of the handle assembly, being the hand-operated-drive-wheel which is attached to engage the shank for holding or spinning the shank, Both halves securely positioned location fixed relative a driver-tools shank and configured to be separately yet simultaneously utilized by a single hand.

A preferred method of operating the assembly while attached upon a driver tool would be to have a user clutch the slip ring type hand-held-guide between a thumb and at least one finger of a hand to direct the tool's shank against work and, as needed, simultaneously bear down with the free portions of the same hand to grasp and hold or grasp and spin the shank-engaged, hand-operated drive-wheel for holding or spinning the shank. The grasping and holding or grasping and spinning may be timed to occur during return strokes of the user's other hand which operates the driver's handle. Clutching the hand-held guide by a portion of a hand to guide the shank also serves to hold the unencumbered portions of the same hand in a position to utilize the drive-wheel. The assembly in whole form is effective for augmenting the ratcheting of a ratchet driver applied to loose fitted work, via the grasping and holding of the hand operated drive-wheel when holding is timed to occur during return strokes of the driver's handle. But additionally, the assembly can be used with any driver fitted with the invention, to further spin the driver's shank during application cycles, through spinning the hand operated drive-wheel on normally unproductive return-stroke-periods of the driver's handle.

### BRIEF DESCRIPTION OF THE DRAWINGS

In the drawings identical components are identified with identical reference numbers and lettering:

FIG. 1 is an exploded perspective side view of the gripwheel driver assembly, the present invention. The figure illustrates shapes which can be used for the slip ring type hand-held guide and hand operated drive-wheel which fall within the scope of the invention as described. The figure also helps illustrate that the method of attaching the guide half the assembly, the method being to have the guide loosely discretely girdling the shank of a driver-tool while separate the drive-wheel to result in the guide's being freely, discretely separately able to spin, unlimited in distance and direction, including relative both the driver's shank used as the axis for the spin and the drive-wheel being a separate utilized half of the assembly, can be accomplished by either one of two manners, the manner in FIG. 1 being by having the slip ring type hand-held-guide loosely discretely girdling the shank of the driver-tool, immediately relative the shank, through way of a bore through the guide sized so that the shank can be directly inserted loosely fitted through the bore, the specific means used to effect the guide's spinning freely as said being, as there is only one, is to have the guide rotationally unengaged in every way relative the shank while linearly fixed in position relative the shank. FIG. 1 also helps illustrate that the method of attaching the drive-wheel half the assembly, the method being to have the drive-wheel ringing so encircling to engage to spin the shank, can be by either one of two manners, the manner in FIG. 1 being to ring the shank fixed to the shank thus engaging the shank, the specific means utilized in the FIG. 1 to effect said engagement being to have the wheel fixed to the shank by jagged surface ridges inside a bore piercing through the drive-wheel, the bore sized small enough for the drive-wheel to be press fitted onto and ringing the shank through way of the bore, the ridges thus digging into the shank's surface thereby fixing the wheel to the shank;

FIG. 2 is an exploded perspective side view of the gripwheel driver assembly, the present invention, illustrating the alternate manner to that illustrated in FIG. 1 of having the slip ring type hand-held-guide loosely girdle a driver's shank, immediately relative the shank, and separate the assembly 's drive-wheel to result in the guide's being freely, discretely separately able to spin, unlimited in distance and direction, including relative both the driver's shank, as axis for the spin, and the drive-wheel, being a separate utilized half of the assembly, the alternate manner being to loosely girdle the shank through way of loosely girdling another component ringing the shank, Also illustrated in FIG. 2 is the attachment method of the drive-wheel along with one of the two possible alternate engagement manners, the engagement manner illustrated in FIG. 2 being the same 15a manner as utilized in FIG. 1, but the specific means utilized to effect engagement, while similar to FIG. 1, differs from FIG. 1 by incorporating a unitized construction of the drive-wheel 14 with a hub 18 as part of the means;

FIG. 3 is an external side plan perspective view of the gripwheel driver assembly as depicted in either FIG. 1 or FIG. 2 but in FIG. 3 the gripwheel device is shown assembled rather than exploded;

FIG. 4 is a partial cross sectional front view of the gripwheel driver assembly of FIG. 2 with the embodiment placed ready for operation attached on a phantom outlined portion of a driver tool. The figure reveals the assembly's drive-wheel engaging a shank by manner in which the drive-wheel had been dressed to do so in FIGS. 1 and 2;

FIG. 5A is a partial cross sectional front view of the gripwheel driver assembly of FIG. 2 with the embodiment placed ready for operation mounted on a phantom outlined portion of a driver tool, but differs from FIGS. 2 and 4 by using the alternate manner to that illustrated in FIG. 1 of having the hand-operated-drive-wheel 14 ringing to encircle-engaged with so to spin a shank, the alternate manner being engagement through linkage by a drive-train 15b in lieu of engagement by means of being fixed to the shank 15a, means utilized in FIG. 5A to engage the shank being a-geared-internal-drive-train;

FIG. 5b is a partial-cross-section side view of the driver's rear-handle-fore-portion 25 depicted in the FIG. 5A front view and reveals the outside housing 40 of the fore-portion 25 plus the section that was cutaway, the cutaway section is still shown but in phantom; and the figure also reveals the other of the two alternate manners of attaching the drive-wheel used along with the method of attaching the wheel, the specific manner illustrated in FIG. 5b being attaching the wheel, in accordance with the method of having the wheel ring to encircle-engaged with a driver's shank, by the manner of linkage using a drive-train for spinning the shank, the specific means utilized to effect the engagement being a geared-internal-drive-train; but also note that FIG. 5b illustrates only components used in attachment of an assembly's drive-wheel, none are intrinsic parts of the assembly itself;

FIG. 6, shows a side plan perspective view of the gripwheel driver assembly as depicted in either FIG. 2, FIG. 4, or FIG. 5A but in FIG. 6 the assembly is attached on a driver-tool along with both alternate embodiments of the tool's rear-driver-handle-fore-portion 25 of FIG. 4 and 25 of FIG. 5A, one driver's handle fore-portion embodiment is used with the assembly's drive-wheel engaging the shank through utilizing the manner of fixing the wheel to the shank and the other embodiment is used with the assembly's drive-wheel engaging the shank through utilizing the manner of a drive train, both fore portions being depicted in phantom, one superimposed over the other, while they are attached to the rest of a driver's handle 27 shown in phantom;

FIG. 7 is a side plan view of a gripwheel driver assembly mounted on a driver tool and illustrates both the work end of the tool and the operating end of the tool plus reveals that the work end of the tool is also the work end of the driver-tool's shank, also the FIG. 7 illustrates the work end of the shank as the free end of the shank; additionally, the figure illustrates that the operating end of the tool is the operating end of the driver-tool's handle;

FIG. 8 is a bottom plan perspective view of the gripwheel driver assembly shown isolated from a driver tool and reveals both the internal face 32 of the drive-wheel 14 and a bore 31 through the drive-wheel;

FIG. 9 is a top plan perspective view of the gripwheel driver assembly shown isolated from a driver tool and reveals a bore 30 through the guide;

FIG. 10 is a side plan exploded view of the gripwheel driver assembly illustrating the slip ring type hand-held guide 13 being slipped into place loosely discretely girdling the shank 33 of a driver-tool;

FIG. 11 is a side plan view of a preferred type ratchet driver tool of genre having a handle with a shank extending perpendicularly from the handle, and is the type to which a gripwheel driver assembly would be attached, the tool being shown isolated from the gripwheel driver assembly, and

FIG. 12 is a sequence of side plan views revealing the recommended hand operations for utilizing the gripwheel driver assembly as mounted on a driver tool and includes arrows denoting the direction of forces applied to both the assembly and through the assembly to the tool.

### DETAILED DESCRIPTION OF THE INVENTION AND METHOD OF ATTACHMENT

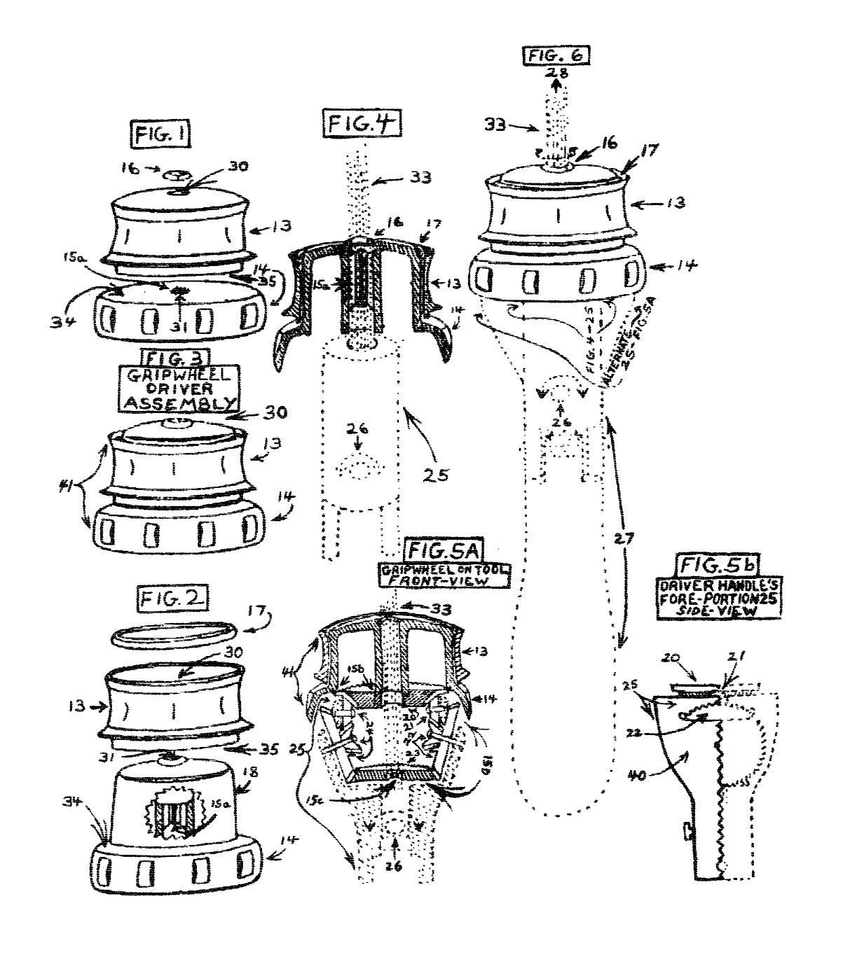

FIG. 1 an exploded perspective side view of the gripwheel driver assembly, the present invention, shows both assembly halves, the slip ring type hand-held-guide half 13 and the hand operated drive-wheel half 14. As FIG. 1 illustrates, the guide 13 and drive-wheel 14 are structured as two separate, positioned, utilized, and functioning components sized such that the distance from at lease one axially-parallel-outward-surface of the guide to axis of the guide is essentially the same as the distance from the overall axially parallel outward surface of the drive-wheel to axis of the drive-wheel, the driver-tool's shank being used as the axis, and both components are sized so that their widths, as placed in line on the shank as axis, are such that a hand is able to grasp the two components simultaneously, and the hand-held-guide's shank-parallel-outward-surface, illustrated in FIG. 1 by showing the guide's shank parallel outward surface concavely shaped and sharply curved, is shaped to enable holding in position on the guide 13 any one portion of a hand-grasping-on-the-shank-parallel-outward-surface of the said guide 13, while the drive-wheel's shank-parallel-outward-surface is shaped for ease of being, simultaneously along with the holding of the guide 13 by a one portion of a hand, intermittently gripped, held, spun, and released by the grasp of any second, remaining not utilized on the guide, portion of the same said hand, illustrated in the FIG. 1 by showing the wheel's shank parallel outward surface convexly shaped and bluntly curved; and additionally, the drive-wheel 14 being a separate utilized and functioning half of the assembly, is shaped with bluntly curved surfaces substantially uniformly symmetrical about the axis of the wheel, to enable the wheel to rotate within the grasp of the releasing, not-utilized-on-the-guide, second portion of the said hand such that the, not-utilized-on-the-guide, second portion of the said hand is able to remain in a positioning for gripping the drive-wheel, and yet also is able to rotate about the drive-wheel near or lightly touching the drive-wheel's surface due to anchoring through linkage with the said hand's one portion which remains utilizing the guide, the guide in addition being discretely freely-rotatable. And also the FIG. 1 helps illustrate that the guide 13 can be attached by method of loosely discretely girdling a driver-tool's shank, the guide freely, discretely separately able to spin, unlimited in distance and direction, including relative the driver's shank as axis for the spin, and assembly's drive-wheel as a separately utilized half of the assembly, by using one of two manners in which the guide could be attached as said, the manner in the FIG. 1 being to have the hand-held-guide, by way of a bore 30 through the guide with diameter large enough to permit the shank to be inserted loosely fitted through the bore, loosely girdle immediately relative of, so to spin directly upon the shank as an axil, the means utilized regardless of manner, as there is only one means, is to have the guide rotationally unengaged with the shank in all ways while linearly fixed relative the shank. And lastly the FIG. 1 also helps to illustrate that the hand operated drive-wheel 14 can be attached on a driver's shank by the method of engaging the shank to spin the shank through using one of two manners in which the drive-wheel could be attached as said, the specific manner used in FIG. 1 being the manner of fixed to the shank to engage for spinning the shank, the means utilized to effect the engagement as said being means of jagged ridges inside a bore 15a through the drive-wheel, the bore being sized small enough for the shank to be tightly press fitted through the bore, the jagged ridges thus digging into the shank's surface thereby fixing the wheel to the shank. Such direct engagement for the drive-wheel enables the wheel to directly spin the shank upon rotation of the wheel.

FIG. 2 another exploded perspective side view of the gripwheel driver assembly, the present invention, illustrates the alternate manner to that illustrated in FIG. 1 of having the guide loosely discretely girdle a driver's shank, immediately relative the shank, and separate the assembly's drive-wheel to result in the guide's being freely discretely separately able to spin, unlimited in distance and direction, including relative both the said driver's shank being axis for the spin, and the assembly's drive-wheel 14 being a separate utilized and functioning half of the assembly, the manner being to have the guide loosely girdling the shank through way of loosely girdling another component that is ringing the shank, illustrated in FIG. 2 by having the drive-wheel's hub extended, the hub-extension 18 inserted through a bore 30 sized through the guide 13 such that the hub 18 extends loosely fitted through the bore 30, the guide thereby loosely girdles the driver's hub freely, discretely separately, able to spin, unlimited in distance and direction relative the hub 18, but the hub 18 in turn will be attached ringing a driver's shank to encircle the shank, as illustrated in the FIG. 2, by having a bore through the hub to be used for insertion of a driver's shank, the guide thereby, through way of the shank's insertion through the hub, will loosely discretely girdle the shank, the guide freely, discretely separately able to spin, unlimited in distance and direction, including relative the driver's shank being axis for the spin and the assembly's drive-wheel being a separate utilized and functioning half of the assembly, the specific means used to effect the guide's being freely spinning as said, regardless of the attachment manner, as there is only one means to have the guide unengaged to the shank in all ways while linearly fixed relative the shank. Also, the FIG. 2 illustrates the attachment method of the drive-wheel, which is to have the drive-wheel ring the shank, encircling-engaged with, to spin the shank; and the manner to engage the shank, one of two manners which can be utilized, the manner illustrated in FIG. 2 being the same manner as illustrated in FIG. 1, that being to engage the shank by way of fixing the wheel to the shank to spin the shank, but the specific means utilized to effect engagement as said, while similar to FIG. 1, differs from FIG. 1 by making use of a unitized construction of the wheel and hub, the hub being fixed to the shank in lieu of the wheel, but the hub uses the same manner and means of the wheel's engagement in FIG. 1, the manner being having a bore piercing through the hub, the means being surface ridges inside the bore and the bore sized small enough to be press fitted tightly onto a shank thereby causing the ridges to dig into the shank's surface thus fixing both the hub and the hub's interconnected wheel to the shank. A cut away of the hub illustrates the shank engagement means 15a.

FIG. 3 an external side plan perspective view of the gripwheel driver assembly shows the gripwheel of either FIG. 1 or FIG. 2, as assembled and ready for attachment to a driver tool. As illustrated in FIG. 3, when either the gripwheel assembly of FIG. 1 or FIG. 2 is assembled for use on a tool as in FIG. 3, both figures depict the same gripwheel form, configuration, overall structure, and, barring the physical elements used to attach the assembly 30 FIGS. 1 and 2; 15a of FIGS. 1, 2, and 4; 16 of FIGS. 1 and 4; 17 of FIGS. 2 and 4; 15D of FIG. 5A, the same basic attachment method, that of attaching the slip-ring-type-hand-held-guide half the assembly to loosely girdling the shank of a driver-tool, the guide being discretely separately adjacent, in line forward of the drive-wheel, and reward of the driver-shank's work end, such that the guide is freely, discretely separately able to spin, unlimited in distance and direction, including relative both the driver-tool's shank and the assembly's drive-wheel; and, attaching the other half the assembly, the hand-operated-drive-wheel, adjacent in line rearward of the guide, forward of a driver's handle, and girdling while engaging the shank, such that the shank will spin with spinning the wheel but the guide spins separate.

FIG. 4, containing a partial cross sectional front view of the gripwheel driver assembly of FIG. 2, shows the assembly placed ready for operation mounted on a phantom outlined portion of a driver tool. As illustrated in the FIG. 4, the required area-on-the-tool's shank 33 which is utilized for the device to function is between the driver-handle's fore-portion 25 and the work end of the shank, the work end of the shank in FIG. 4 shown as the free end of the shank 33. As also illustrated, the hand-operated-drive-wheel 14 using a direct engaging means, 15a, fixes the drive-wheel to the shank 33, and the hand-held-guide 13, being attached discretely, separately, loosely girdling the shank, is thus able to be spun separately from the drive-wheel and shank. Also illustrated in FIG. 4, when the drive-wheel utilizes a means to engage the shank by being fixed to the shank, the engagement doesn't require involvement with the driver-handle's fore-portion 25.

FIG. 5A, a partial cross sectional front view of the gripwheel driver assembly of FIG. 2 has the assembly attached ready for operation on a phantom outlined portion of a driver-tool, but while FIGS. 1, 2, and 4 illustrate the manner of the drive-wheel's engagement with shank to spin the shank as being by way of fixing the wheel to the shank, the FIG. 5A illustrates the other of the two alternate manners of having the hand-operated-drive-wheel 14 attached in according with the method of ringing to encircle-engaged with a shank to spin the said shank, the alternate manner being to engage the shank by linkage through way of a drive-train, the specific means utilized in FIG. 5A to effect engagement as said is by using a geared-internal-drive train 15b in lieu of being fixed to the shank by being pressed tightly onto a shank while having surface ridges fixed to the wheel to dig into the shank's surface thereby fixing the wheel to the shank 15a. As the FIG. 5A illustrated, the preferred component parts of a geared-internal-drive-train would be the following: a driving-gear 20 directly-engaging and therewith fixed 15a to the internal face of the hand operated drive-wheel 14; an idler-gear 21 engaging with the driving-gear 20; a step-up-gear 22 engaging with the idler-gear 21; a driven-gear 23 which is both engaging the step-up-gear 22 and ringing to encircle engaged with and thus fixed 15c to the tool's shank; and the gearing arrangement 24 which is a repeat of 21-22 in bilateral symmetrical fashion. Also illustrated in FIG. 5A and differing from FIG. 4, the driver-handle's fore-portion 25, due to the drive-train's involvement with the handle fore portion, is configured to have the gears of the drive-train 15b able to spin while mounted on axils affixed to the driver handle's fore-portion.

FIG. 5b, partial-cross-section side view of the driver's rear-handle-fore-portion 25 which was depicted in the FIG. 5A front view, reveals the outside housing 40 of the fore-portion 25 and the section that was cutaway, the cutaway section still shown but in phantom; also the figure reveals the other of the two alternate manners of attaching the drive-wheel which is used along with the method of attaching the wheel, the specific manner illustrated in FIG. 5b being attaching the wheel, in accordance with the method of having the wheel ring to encircle-engaged with a driver's shank, by the manner of linkage using a drive-train for spinning the shank, the specific means utilized to effect the engagement being a geared-internal-drive-train; the figure additionally reveals that the driver-handle's housing 40 can wrap behind the step-up-gear 22 for use as a platform to mount the idler gear 21, but note that the FIG. 5b illustrates only components used in the attachment of an assembly's drive-wheel and none are intrinsic parts of the assembly itself.

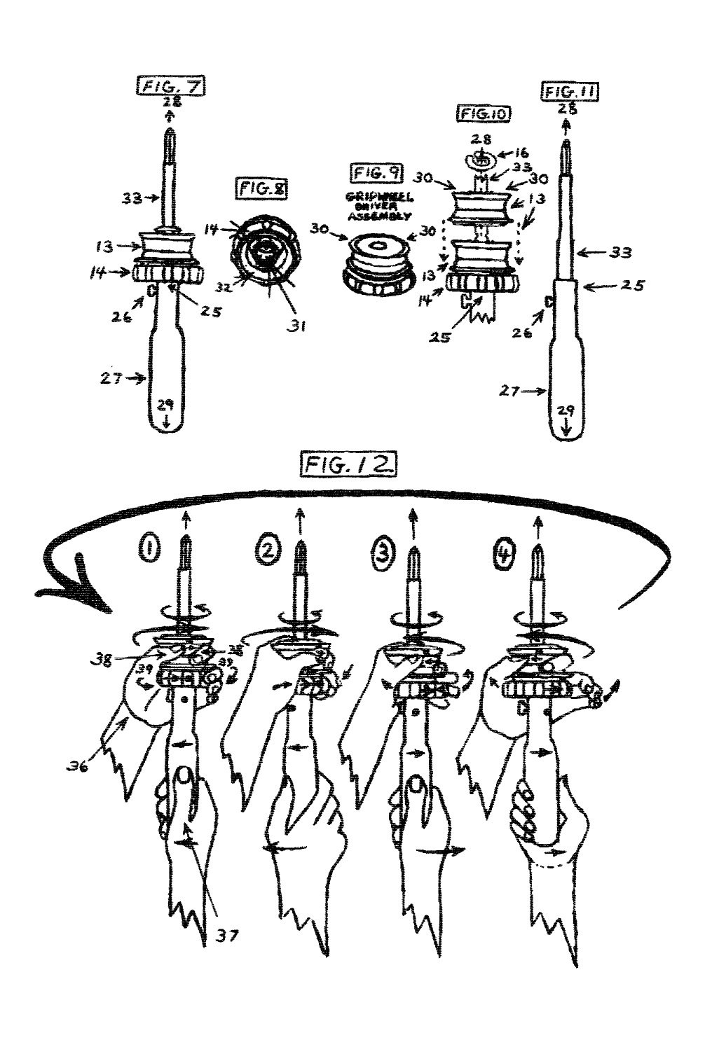

FIG. 6, a side plan perspective view of the gripwheel assembly shown in either FIGS. 1, 2, 3, 4, or 5A illustrates the assembly attached on a phantom outline of a driver too having both alternate embodiments of the rear-driver-handle-fore-portion 25 of FIG. 4 and 25 of FIG. 5A in phantom, one superimposed over the other, while they are attached to the rest of a driver's rear-handle 27 shown in phantom. As illustrated by FIG. 6, all the embodiments, FIGS. 1, 2, 3, 4, and 5A of the gripwheel assembly assembled and attached on a tool have essentially the same form, configuration, structure, and, barring the physical elements used to attach the assembly 30 FIGS. 1 and 2; 15a of FIGS. 1, 2, and 4; 16 of FIGS. 1 and 4; 17 of FIGS. 2, and 4; 15D of FIG. 5A, the same attachment method, that of attaching the slip-ring-type-hand-held-guide to loosely girdling the shank of a tool discretely separately adjacent in line forward of the drive-wheel and reward of the driver-shank's work end, such that the guide is freely, discretely separately able to spin, unlimited in distance and direction, including relative both the driver's shank and the assembly's drive-wheel; and also attaching the hand-operated-drive-wheel, other half the assembly, separately adjacent in line, rearward of the guide, forward of a driver's handle, and girdling while engaging the shank, such that the shank will spin with spinning of the wheel but the guide spins separate. Also illustrated in FIG. 6 is a ratchet driver direction setting means, 26 shown in phantom, but the setting means has no mechanical bearing on the gripwheel handle assembly.

FIG. 7, a side plan view of a gripwheel driver assembly mounted on a driver tool illustrates both the work end 28 and operating end 29 of the tool plus reveals that the work end of the tool is also the work end of the driver-tool's shank 33, also the FIG. 7 illustrates the work end of the shank 33 as the free end of the shank 33. Additionally, the figure illustrates that operating end of the tool is the operating end of the driver-tool's handle. Orientation of the gripwheel's component parts relative the tool's work end 28 and operating end 29 is also revealed.

FIG. 8 a bottom plan perspective view of the gripwheel driver assembly, shown isolated from a driver tool, reveals the internal face 32 of the drive-wheel and a bore 31 through the wheel. The bore 31 is one means which can be used for the drive-wheel to be attached ringing a driver-tool's shank encircling to be engaged with the said shank, the means being having the wheel's bore sized for insertion of the driver's shank while the wheel is also dressed to engage the shank as 15a of FIG. 4 or 15D of FIG. 5A.

FIG. 9 a top plan perspective view of the gripwheel driver assembly, shown isolated from a driver tool, reveals a bore 30 in the slip ring type hand-held-guide. The bore is one means which could be used for the guide to be attached loosely girdling the shank of the tool and separate the drive wheel to result in the guide's being freely, discretely separately able to spin, unlimited in distance and direction, including relative both the driver's shank and the assembly's drive-wheel, the means being having the guide's bore sized large enough for having the shank inserted loosely fitted through the bore such that the guide is discretely separately freely able to rotate about the driver's shank.

FIG. 10, a side plan exploded view of the gripwheel driver assembly is depicting the method of attaching the gripwheel components to a driver tool. As FIG. 10 illustrates, the slip ring type hand-held-guide 13 is slipped into place loosely discretely girdling the shank of the driver-tool and separate the assembly's drive-wheel 14 by a method resulting in the guide's being freely, discretely separately able to spin, unlimited in distance and direction, including relative both the driver's shank 33 used as axis for the spin and the assembly's drive-wheel 14, as being a separate utilized and functioning half of the assembly. The method illustrated is by inserting the shank 33 through a bore 30, larger in diameter than the shank and piercing through the guide 13, to a distance on the shank from the shank's work end 28 FIG. 7 such that the guide is girdling rearward of in line with the shank's work end 28, the guide being retained in the guide's location on the shank; and the location on the shank the guide girdles is also in line forward the work side of the drive-wheel 14, the drive-wheel located ringing to encircle the shank but “utilizing a manner of engaging upon the shank 33” to spin the shank 33, the location the wheel is ringing on the shank being even further in line rearward on the shank than the guide's location from the work end 28 of the shank, the wheel being retained in the wheel's location on the shank; and the location on the shank which the wheel rings is also in line forward the work end of the driver's handle, the work-end of the driver's handle being the fore-portion 25 of the handle, the handle being a part of the tool which is attached engaging upon and in line with the rear end of the tool's shank 33, the opposite shank-end from the tool's work end 28 FIG. 7 to spin the shank 33, thus the driver's handle is in line rearward the drive-wheel 14, the drive-wheel is in turn, in line rearward the guide 13, and the guide is in turn, in line rearward the work end of the shank; and both the gripwheel halves, the guide and wheel, are attached advantageously positioned near enough each other between the fore portion of the driver's handle 25 and the tool's work end, such that a single hand is able to simultaneously grasp both the guide and drive-wheel utilizing them as bilaterally supporting halves.

FIG. 11, a side plan view of a preferred type driver tool of the genre having a handle and a shank extending perpendicularly from the handle and being of the type which a gripwheel driver assembly would be attached, shows the tool isolated from the assembly.

FIG. 12, a sequence of side plan views, shows the recommended hand operations for utilization of the gripwheel driver assembly as mounted on a driver tool. The FIG. 12 reveals the preferred hand positions and motions of the hand upon and about the assembly as relative the driver-tool, and the figure also includes arrows denoting direction of forces applied by the hand to the assembly and through the assembly to the tool.

Referring now to FIGS. 1, 2, 4, 5A, 6 and 11, the gripwheel driver assembly, as in FIGS. 1 and 2, being a means for guiding and actuating, comprises a slip ring type hand-held-guide-half 13 and a hand-operated drive-wheel half 14, each used in conjunction with the other, both attached as the assembly to a driver-tool of the genre of type show in FIG. 11, such that the assembly is located between the 28 FIG. 6 work end of the driver tool's shank 33 FIG. 6 and the work end of the driver-handle's fore-portion, for example 25 FIG. 6 of driver tool handle 27 in FIG. 6. The hand-held-guide half 13 FIG. 10 of the assembly is attached to the driver-tool by method of loosely girdling the shank 33 FIG. 10 of the tool and separate while nearer the tool's work end 28 FIG. 10 than the drive-wheel half the assembly 14 FIG. 10, such that the guide 13 FIG. 10 is freely, discretely separately able to spin, unlimited in distance and direction, including relative both the driver's shank 33 and the assembly's drive-wheel 14, and the manner of being attached as said is either by directly loosely girdling immediately relative the shank, or loosely girdling the shank by way of loosely girdling another component 18 FIG. 2 which rings the shank, and the means utilized to effect being freely able to spin separate is that of having the guide rotationally unengaged in any way with the shank while linearly fixed relative the shank. The drive-wheel 14 is attached to the driver-tool by method of ringing the shank 33 while rearward the guide's location from the shank's work end, such that the wheel is ringing the shank to encircle-engaged with to spin the shank 33 either in the manner of directly engaging the shank or engaging the shank through manner of linkage by way of a drive train, the means utilized to effect the wheel's engagement being any of several available, one for example being a jagged bore sized to be press fitted about the shank 15a FIGS. 1, 2 and 4, thus engaging through being directly fixed to the shank to spin said shank or another being a geared internal drive train linking the fixed attachment of the drive-wheel to a driving-gear 15b with the fixed attachment of a driven-gear to the shank 15c, such as the 15D drive-train in FIG. 5A, to result in the wheel engaging the shank to spin the said shank. Both the guide 13 and the drive wheel 14 are located such that they are near enough each other so that a single hand is able to utilize them simultaneously. The linear movement of the guide 13 relative the shank 33 is fixed by a retainer such as 16 FIG. 1 or 17 FIG. 2 and the linear movement of the drive-wheel 14 is also fixed relative the shank 33 either by its engagement method upon the shank 33 which can fix it to the shank 33 or by its positioning, as in FIG. 6, being sandwiched between the fixed position of the driver's main handle fore-portion 25 and hand-held-guide 13 which is linearly fixed in position as by retainer, such as 16 and 17.

Referring now to FIGS. 7, 11 and 12, using a preferred method of operating the gripwheel driver assembly, the operator would first grasp the slip ring type hand-held-guide 13 between a thumb and at least one finger of a hand 36, the hand one first portion 38 of FIG. 12, to guide the driver's shank 33 toward the work, FIG. 12 OPERATION 1, and thereupon, the operator would keep the first hand portion 38 upon the guide to use the first hand portion for guiding and holding the shank against work, and at the same time the user rocks the driver's rear-handle 27 FIG. 12 counter clockwise using the other hand 37 FIG. 12, the motion counter clockwise being a rear handle return stroke, until the other hand reaches its maximum rotational extension, FIG, 12 OPERATION 2. While the other hand 37 FIG. 12 is moving to its maximum counter clockwise extension, the operator bears down and grips the hand-operated-drive-wheel 14 with a second portion of hand one, which remained-not-utilized-for-holding-onto-the-guide 39 FIG. 12, to rock the drive-wheel 14 clockwise thus spinning the shank 33 clockwise, FIG. 12 OPERATION 2. The hand one portion 38 FIG. 12 holding onto the guide is kept on the guide and continues to remain on the guide during all operations allowing the guide to fulfill another role which is that of being means to anchor the hand-one 36 FIG. 12 in just such an advantageous position to have the hand one's second portion not used on the guide 39 FIG. 12 grasp to spin as needed the shank engaged drive-wheel 14. Note that when the assembly is mounted on a ratchet-driver-tool, such as the tool of FIG. 11, and the tool is used on loose fitted work, just holding the drive-wheel 14 during return strokes of the rear-shank-handle 27 FIG. 7 will augment the ratcheting action of the driver. Spinning of the drive-wheel 14 will, on any driver fitted with the assembly, further spin the shank if the spinning is applied during normally unproductive return-stroke periods of the driver's rear handle 27 FIG. 7. Continuing to describe the gripwheel operation, when both the operator's hands reach maximum rotated extensions in their respective rotating directions, the operator would release the hand-one second-portions 39 FIG. 12 from gripping upon the drive-wheel, releasing the drive-wheel, FIG. 12 OPERATION 3, and thereupon reverse rotation of the other hand 37 FIG. 12 gripping on the driver's rear-handle, rocking the other hand clockwise, the other hand now is continuing the clockwise spin of the shank by clockwise spinning the rear-handle attached to the shank. The hand one's second-portion that is released away from the drive wheel 39 along with the hand one's first-portion that remains on the guide 38, freely reverse direction bringing along in rotation the slip ring type hand-held guide 13 still held by the hand one first portion, and they all rock counter clockwise about plus above the clockwise-moving drive-wheel which moves due to linkage by way of the engagement with the shank being spun by the other hand, the shank spun by the other hand through said hand's spinning of the driver's rear handle which is engaged with the shank, FIG. 12 OPERATION 4, both hands continuing their operations until all arrive at their maximum extensions, the starting position FIG. 12 OPERATION 1. The hands then begin another cycle of gripwheel plus driver-tool use.

Referring now to FIG. 1, FIG. 3 and FIG. 6, the method of attaching the assembly's drive-wheel half 14 FIG. 3 comprises having the wheel ring a driver-tool's shank to engage the shank 33 FIG. 6. In using the said attachment method, the manner in which the wheel engages the shank can be in either one of two ways, one being engaging the shank by being fixed to the shank, as for example by using 15a FIG. 1 a jagged bore through the wheel to be press fitted about the shank fixing the wheel to the shank 33 FIG. 6. However the means used to effect the wheel's being fixed to the shank thus engaging the shank can be any one of many, for example another means would be glue to adhere the wheel to the shank or another would be to have the shank itself expanded to form the drive-wheel component. The method of attaching the assembly's slip ring type hand-held-guide 13 FIG. 1 comprises having the guide girdle loosely and discretely the shank of the driver-tool and separate the assembly's drive-wheel to result in the guide's being freely, discretely separately able to spin, unlimited in distance and direction, including relative both the driver's shank and the assembly's drive-wheel. In using the said attachment method, the manner in which the guide is enabled to said spin freely can be in either one of two ways, one way being to loosely girdle the shank, the guide immediately relative the shank, as for example by utilizing 30 a bore through the guide for having the driver's shank inserted directly through the bore loosely fitted thus the guide would be able to spin freely discretely separately upon the shank as axil. However the means used to effect the guide's being able to spin freely about the shank is only one, that being to have the bore unengaged, not engaged directly nor through linkage, with the shank.

Referring now to FIGS. 5A, and 8, the second manner, other than the previously mentioned manner, of having the drive-wheel engage the shank through being fixed to the shank would be for the drive-wheel to engage the shank through linkage by way of a drive train, as for example the 15D in FIG. 5A geared-internal-drive-train having a beveled-driving-gear 20 FIG. 5A, loosely girdling the shank 33 FIG. 5A, but centered and engaged, 15b FIG. 5A, upon the drive-wheel's internal face 32 FIG. 8 so as to be fixed upon the wheel 14 FIG. 5A, the beveled-idler-gear 20 FIG. 5A engaging a beveled-idler-gear 21 FIG. 5A able to spin by being mounted at its center on an axil affixed to the driver-handle's fore-portion 25 FIG. 5A, the same beveled-idler-gear 21 FIG. 5A engaging a step-up-gear 22 FIG. 5A, able to be spun by being mounted at its center on an axle affixed to the driver-handle's fore-portion 25 FIG 5A, the second-beveled-step-up-gear engaging a girdling-while-directly-engaged 15c FIG. 5A with-the driver's-shank 33 FIG. 5A driven-gear 23 FIG. 5A, and the aforementioned gearing arrangement 21 thru 22 of FIG. 5A can be repeated 24 of FIG. 5A in bilaterally symmetrical fashion on the shank's, driven-gear's, and driving-gear's opposite side.

Referring now to FIG. 2, FIG. 3, and FIG. 6, the second manner, other than the previously mentioned manner of having the assembly's slip ring type hand-held-guide 13 of FIG. 3 loosely discretely girdle the shank of a driver-tool and separate the assembly's drive wheel 14 to result in the guide's being freely, discretely separately able to spin, unlimited in distance and direction, including relative the shank as axis 33 FIG. 6 and drive-wheel 14 being a separate utilized half of the assembly, is to have the 30 FIG. 2 bore through the guide 13 sized large enough to be loosely fitted about another component which rings to encircle the shank 33, for example the bore 30 through the guide 13 FIG. 2 could be sized large enough to be loosely fitted girdling an extension of the drive-wheel'hub 18 FIG. 2 thereby the guide would be freely, discretely separated able to spin unlimited in distance and direction relative the extension of the drive-wheel's hub 18 FIG. 2; however, the hub 18 FIG. 3 having been constructed to ring a shank so to encircle engaged with the shank will in turn enable the discretely attached guide 13 FIG. 2 to be freely, discretely separated able spin relative the shank, relative the hub, and plus relative the hub's attached wheel.

Referring to FIGS. 6 and 12, operation of the assembly on a ratchet driver such as depicted in FIG. 6 remains basically the same whatever the setting of the driver's ratchet-direction setting means 26 FIG. 6 as the hand is still merely lifted off the Drive-Wheel 14 FIG. 6 during Drive-Wheel return strokes, the hand's operating position and stance are maintained during the lift via the anchoring of the hand by the griping of the hand's one portion upon the slip ring type hand-held guide 13 FIG. 6. The hand-held guide 13 FIG. 6 supports the hand lifting plus return stroke operation through having been mounted rotationally free yet linearly fixed

### TERM LIST FOR PATENT APPLICATION

FIG. 1 Exploded view of the gripwheel driver assembly illustrating one of the manners of having the guide half of the assembly spin freely relative, while girdling upon, a shank used as axil, the manner being through spinning freely as immediately upon the shank by way of the shank being inserted through a bore piercing through the guide, the specific means used to effect rotating freely as such being having the guide rotationally unengaged to the shank 7 in any way

FIG. 2. Exploded view of the gripwheel driver assembly illustrating one of two manners of having the guide half of the assembly spin freely relative, while girdling upon, a shank used as axil, the manner being through spinning freely as upon another component ringing the shank by way of the shank being inserted through a bore piercing through the other component, the other component piercing through a bore piercing through the guide, the specific means used to effect rotating freely as such being having the guide rotationally unengaged to the shank in any way

FIG. 3 Gripwheel driver assembly as assembled

FIG. 4 Cross section of a gripwheel driver assembly on a driver tool, the drive-wheel half of the assembly shown engaging a shank by direct manner

FIG. 5A Cross section of a gripwheel driver assembly on a driver tool, the drive-wheel of the assembly shown engaging a shank by manner of a drive-train

FIG. 5b Partial-cross-section side view of the rear-driver-handle-fore-portion 25 depicted in FIG. 5A front view with cutaway portion depicted in phantom

FIG. 6 Gripwheel driver assembly on a driver tool, both manners of engaging the assembly's drive wheel to a driver's shank are shown illustrated in phantom, one manner being directly fixed to the shank, the other way being through linkage using a drive train, the assembly itself remaining the same

FIG. 7 Gripwheel driver assembly on driver tool, the tool's work end and operating end revealed

FIG. 8 Gripwheel driver assembly bottom plan perspective view revealing the drive-wheel's internal face

FIG. 9 Gripwheel driver assembly top plan perspective view revealing a bore through the slip ring type hand-held-guide which would be used to have the guide loosely girdling a driver's shank

FIG. 10 Side plan exploded view revealing the slip ring type hand-held-guide being slipped into place loosely girdling a driver's shank

FIG. 11 Side plan view of a preferred type driver-tool of the genre to which a gripwheel driver assembly would be attached

FIG. 12 Recommended sequence of hand operations for utilization of the gripwheel driver assembly as mounted on a driver tool

13 Slip ring type hand-held-guide

14 Hand operated drive-wheel

15a Engaging by being fixed upon, one of the two manners of engaging, the specific means illustrated being ridges to be press fitted upon thereby gripping upon a surface

FIG. 15b The drive-wheel's fixed engagement upon the driving-gear by having the wheel's internal face fixed to one side of the driving-gear

15c Driven gear's fixed engagement upon the shank through girdling fixed upon the shank

15D Engaging through linkage by way of a drive train, one of two manners of engaging, the specific means illustrated being a geared internal-drive train to equalize the ability of one hand, positioned on side of a tool, to spin a handle on the tool, with the ability of the other hand, positioned on rear of the tool, to spin an other handle on the tool

16 Retaining ring

17 Retaining ring different from 16

18 Drive-wheel hub

20 Driving-gear

21 Idler-gear

22 Second-idler-gear

23 Driven-gear

24 Bilateral repeat of gearing arrangement

25 Driver handle's fore-portion (the rear-driver-handle fore-portion, the fore-portion of a driver's main handle)

26 Ratchet direction setting means

27 Driver's handle (rear driver handle, the driver's main handle)

28 Work end of driver tool, work end of the driver's shank (free end of the s shank

29 Operating end of driver tool, operating end of the driver's handle (operating end of the rear driver handle, the driver's main handle)

30 Bore in slip ring type hand-held-guide enabling guide to girdle free to rotate relative a shank

31 A bore through hub and drive-wheel which can be used to enable hub and drive-wheel to girdle, engaged and fixed, upon a shank

32 Drive-wheel's internal face

33 Driver's shank

34 External face of drive-wheel that is to face the work end of tool

35 Rear face of slip ring type hand-held-guide that is to face the drive-wheel

36 Hand one of operator used on gripwheel

37 Hand two of operator used on driver's handle (rear driver handle, driver's main handle)

38 First portion of hand one which continuously holds the slip ring type hand-held guide

39 Second portion of hand one, not used on slip ring type hand-held guide, but used to operate drive-wheel

40 Housing of the driver-handle's fore-portion (housing of rear driver handle, the driver's main handle)

41 Gripwheel driver assemble relative the shank by retainer such as 16 and 17 of FIG. 6, the guide as being so retained rotational in location relative the shank will spin in concert with any one portion of a hand 38 FIG. 12 gripping it, freeing any unencumbered second portion of the hand 39 FIG. 12 not gripping on the guide to move rotationally as needed to bear down and grip and hold or grip and spin the drive-wheel as needed 14 FIG. 6.

It should be noted and understood that drawings and descriptions herein are illustrative of the gripwheel assembly's appearance and means both depicted and described herein to effect the gripwheel's method of attachment are illustrative of types which could be utilized; therefore if a gripwheel assembly's structure is within the scope of the prescribed structure as hereinafter claimed and attachment of the gripwheel components are within the scope of the attachment method as hereinafter claimed, then various materials, colors, and embodiment shapes plus various means to effect attachment of each gripwheel component may be used without departing from the spirit and scope of the invention as hereinafter claimed.

What is claimed:

1. Both a handle assembly utilized attached on a driver tool and the method of attaching the assembly to the driver-tool, the tool being of a genre already possessing a handle and a shank extending perpendicularly from the handle, the assembly comprising two separate shaped, positioned, utilized, and functioning halves, a discretely rotatable slip ring type hand-held-guide and a rotatable hand-operated driver-shank's drive-means referred to herein as a drive-wheel, both components structured ad sized such that the distance from at lease one axially-parallel-outward-surface of the guide to axis of the guide is essentially the same as the distance from the overall axially parallel outward surface of the drive-wheel to axis of the drive-wheel, the driver-tool's shank being used as the axis, and both components are sized so that their widths, as placed in line on the shank as axis, are such that a hand is able to grasp the two components simultaneously, and the hand-held-guide's shank-parallel outward-surface is shaped to enable holding in position on the guide any one portion of a hand grasping on the-shank-parallel-outward-surface of the said guide, while the drive-wheel's shank-parallel-outward-surface is shaped for ease of being, simultaneously along with the holding of the guide by a one portion of a hand, intermittently gripped, held, spun, and released by the grasp of any second, remaining not utilized on the guide, portion of the same said hand; and additionally, the drive-wheel being a separately utilized and functioning half of the assembly, is shaped with bluntly curved surfaces substantially uniformly symmetrical about the axis of the wheel, to enable the wheel to rotate within the grasp of the releasing, not-utilized-on-the-guide, second portion of the said hand, such that the, not-utilized-on-the-guide, second portion of the said hand is able to remain in a positioning for gripping the drive-wheel, and yet also is able to rotate about the drive-wheel near or lightly touching the drive-wheel's surface due to anchoring through linkage with the said hand's one portion which remains utilizing the guide, the guide in addition being discretely freely rotatable; the assembly's method of attachment comprising, having the slip ring type hand-held-guide slipped into place “loosely discretely girdling the shank of the driver-tool and separate the assembly's drive-wheel to result in the guide's being freely, discretely separately able to spin, unlimited in distance and direction, including relative both the driver's shank as axis for the spin, and the assembly's drive-wheel as a separate utilized and functioning half of the assembly, the attachment being by having the shank inserted through a bore”, larger in diameter than the shank and piercing through the guide, to a distance on the shank from the shank's work end such that the guide is girdling rearward of in line with the shank's work end, the guide being retained in the guide's location on the shank; and the location on the shank the guide girdles is also in line forward the work side of the drive-wheel, the drive-wheel being located ringing to encircle the shank but “utilizing a manner of engaging upon the shank” to spin the shank, the location the wheel is ringing on the shank being even further in line rearward on the shank than the guide's location from the work end of the shank, the wheel being retained in the wheel's location on the shank; and the location on the shank which the wheel rings is also in line forward the work end of the driver's handle, the work end of driver's handle being the fore-portion of the handle, the driver's handle being a part of the driver-tool which is attached engaging upon and in line with the rear end of the tool's shank, the opposite shank end from the driver-shank's work end, the driver's handle being for spinning the shank, thus the driver's handle is in line rearward the drive-wheel, the drive-wheel is in turn, in line rearward the guide, and the guide is in turn, in line rearward the work end of the shank; and both the gripwheel halves, the guide and wheel, are attached advantageously positioned near enough each other between the fore-portion of the driver's handle and the driver-shank's work end, such that a single hand is able to simultaneously grasp both the guide and drive-wheel utilizing them as bilaterally supporting halves, and at least one retainer is placed, a retainer in front of the hand-held guide's side which is facing the shank's work end, the retainer to help retain the components in assembled operating position.

2. A handle assembly as described in claim 1 for use on a driver-tool wherein the said drive-wheel half of said auxiliary handle, “utilizing a manner of engaging upon said shank”, engages upon the shank by manner of ringing the shank to encircle fixed upon the shank, thereby engaging upon the said shank.

3. A handle assembly as described in claim 2 for use on a driver-tool wherein the said drive-wheel half of said auxiliary handle, “utilizing a manner of engaging upon said shank”, engages upon the shank by way of a drive-train, the train's driving component being fixed to said drive-wheel and the train's driven component being ringing to encircle fixed upon the shank, thereby the wheel engages the shank through linkage by way of the train.

4. A handle assembly as described in claim 3 for use on a driver-tool wherein the said slip ring type hand-held-guide half of said assembly is “loosely discretely girdling the shank of the tool and separate the drive wheel to result in the guide's being freely, discretely separately able to spin, unlimited in distance and direction, including relative both the shank and drive-wheel, by having the shank inserted through a bore”, loosely girdles the shank as by manner of having the guide loosely discretely girdling immediately relative the shank inserted through the bore through said guide.

5. A handle assembly as described in claim 3 for use on a driver-tool wherein the said slip ring type hand-held-guide half of said assembly is “loosely directly girdling the shank of the tool and separate the drive wheel to result in the guide's being freely, discretely separately able to spin, unlimited in distance and direction, including relative both the shank and drive-wheel, by having the shank inserted through a bore ”, loosely girdles the shank as by manner of having the guide loosely discretely girdling upon another component inserted through the bore through the said guide, the other component being ringing to encircle the said shank.
